(19) United States
(12) Patent Application Publication
(10) Pub. No.: US 2013/0256320 A1
(43) Pub. Date: Oct. 3, 2013

(54) Dispenser Apparatus

(71) Applicant: Mostafa Sorkhabi, Fremont, CA (US)

(72) Inventor: Mostafa Sorkhabi, Fremont, CA (US)

(21) Appl. No.: 13/761,131

(22) Filed: Feb. 6, 2013

Related U.S. Application Data
(60) Provisional application No. 61/618,633, filed on Mar. 30, 2012.

(51) Int. Cl. A47J 43/00

(52) U.S. Cl. CPC A47J 43/00
USPC 220/592.25; 220/500; 220/592.2; 220/705

(57) ABSTRACT

A solid and liquid dispenser apparatus allows a food and a beverage to be simultaneously consumed from the same container with one hand. The apparatus includes a solid dispenser body that securely attaches above a liquid dispenser body. A segregation portion separates the bodies, provides a secure attachment between the bodies, and forms a spill proof seal between the bodies. The solid dispenser body serves as both a lid for the liquid dispenser body and a container for the solid. The solid dispenser body compartmentalizes to segregate an eclectic variety of solids. At least one aperture positions on a peripheral wall of the solid dispenser body and the segregation portion. A straw passes through the aperture, whereby the straw engages the liquid in the lower liquid dispenser body. An insulating portion positions between the bodies to at least partially restrict thermal transfer between the solid and the liquid.

### CROSS-REFERENCE TO RELATED APPLICATIONS

The present Utility patent application claims priority benefit of the U.S. provisional application for patent Ser. No. 61,618,633 entitled “Segregated Food and Beverage Dispenser”, filed on 30 Mar. 2012 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to dispensers. More particularly, the invention relates to segregated food and beverage dispensers.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that solid dispensers are utilized for containing myriad varieties of foods and food condiments. Plates, pots, trays, and bowls are just some of the different types of food containers. The solid dispenser is efficacious in efficiently receiving a portion of food for a consumer.

Typically, liquid dispensers, used to contain beverages are ubiquitous in society. Ancients utilized an assortment of clay and ceramics to form cups, bowls, pitchers, and any other type of sealed container that could contain liquids. Often, liquid containers provided insulation to prevent heat loss, or keep liquids cold.

Typically, the two types of containers serve the consumer separately. The consumer must focus on one, before starting on another. The consumer must also utilize both hands when consuming from the food container and the liquid container.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary dispenser apparatus, in accordance with an embodiment of the present invention;

FIG. 2 illustrates a perspective view of an exemplary dispenser apparatus with an exemplary barrier and an exemplary peripheral wall, in accordance with an embodiment of the present invention;

FIG. 3 illustrates a top view of an exemplary solid dispenser body, in accordance with an embodiment of the present invention;

FIG. 4 illustrates a side view of a side view of an exemplary dispenser apparatus, in accordance with an embodiment of the present invention;

FIG. 5 illustrates a perspective view of an exemplary liquid dispenser body with an exemplary aperture positioned directly into the liquid dispenser body for passing an exemplary straw through, in accordance with an embodiment of the present invention;

FIG. 6 illustrates a perspective view of an exemplary liquid dispenser body separate from a solid dispenser body, and having an exemplary straw positioned directly into an exemplary aperture, in accordance with an embodiment of the present invention;

FIG. 7 illustrates a perspective view of an exemplary dispenser apparatus with an exemplary food positioned inside an exemplary solid dispenser body, in accordance with an embodiment of the present invention;

FIG. 8 illustrates a sectioned view of an exemplary dispenser apparatus with an exemplary aperture for inserting an exemplary straw located between an exemplary solid dispenser body and an exemplary liquid dispenser body, in accordance with an embodiment of the present invention;

FIG. 9 illustrates a top view of an exemplary solid dispenser body with an exemplary aperture positioned inside an exemplary peripheral wall around the perimeter of the solid dispenser body, in accordance with an embodiment of the present invention; and

FIG. 10 illustrates a top view of an exemplary solid dispenser body with an exemplary aperture positioned outside an exemplary peripheral wall around the perimeter of the solid dispenser body, whereby the straw does not contact the food, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of food and liquid dispensers that may be provided by preferred embodiments of the present invention. In one embodiment of the present invention, a dispenser apparatus may allow a user to simultaneously consume a liquid and a food from the same container with minimal attention or visual confirmation of the food or liquid being required. The dispenser apparatus may segregate the liquid from the food and provide accessibility to both liquid and the food simultaneously. In some embodiments, at least one aperture and a straw may facilitate access to the liquid. At least one barrier may serve to compartmentalize the food to allow for an eclectic assortment of foods and condiments. Those skilled in the art, in light of the present teachings, will recognize that the dispensing apparatus may be utilized for snack type foods, and often utilized while the attention of a user is on other events, such as sporting events, work, or television.

In one embodiment of the present invention, the dispenser apparatus may include a solid dispenser body, which may position above and securely mate with a liquid dispenser body. The solid dispenser body may contain food, while the liquid dispenser body may contain a liquid for consumption. An insulated segregation portion may separate the solid dispenser body from the liquid dispenser body. In some embodiments, a peripheral wall may provide an external barrier for retaining the food and liquid inside the respective body. In some embodiments, the dispersion apparatus may allow a user to eat the food directly from the solid dispenser body, which may also serve a dual purpose of containing the food and acting as a lid for liquid dispenser body. At least one barrier may segment the solid dispenser body into variously sized and dimensioned compartments. In one embodiment, solid dispenser body positions on top of liquid dispenser body. However, in other embodiments, the solid dispenser body may position beneath the liquid dispenser body. An insulation portion may sandwich between them to regulate the flow of thermal energy.

In one embodiment of the present invention, the liquid dispenser body may receive the liquid, which in one embodiment is accessible with a straw. The liquid may include a cold or hot beverage that correlates with the type of food in the solid dispenser body. The liquid and food may include, without limitation, peanuts and coke, cookies and hot chocolate, and popcorn and soda. In this manner, the user may simultaneously consume the food and the liquid with one hand.

In one embodiment of the present invention, the operation, the solid dispenser body and the liquid dispenser body may be segregated with at least one barrier. The liquid may be portioned into the liquid dispenser body, and the food may be portioned into the solid dispenser body. In some embodiments, different foods may be segregated in the solid dispenser body, depending on the amount of the at least one barrier utilized. The insulating portion may be positioned above the liquid dispenser body. The solid dispenser body may be securely mated on top of the liquid dispenser body, sandwiching the insulating member securely in the middle. A straw may pass through the aperture until the straw engages the liquid. A user may then be able to simultaneously consume the liquid and the food with one hand.

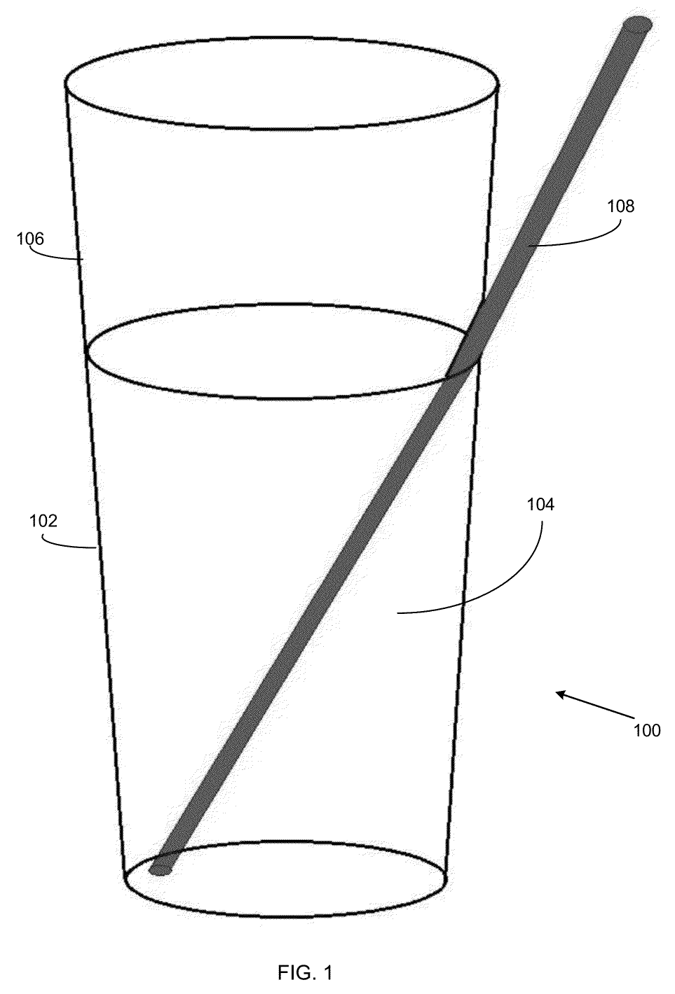

FIG. 1 illustrates a detailed perspective view of an exemplary dispenser apparatus, in accordance with an embodiment of the present invention. In the present invention, the dispenser apparatus 100 may include a liquid dispenser body 102 used to contain and dispense a liquid 104. Those skilled in the art, in light of the present teachings, will recognize that myriad shapes and volume are possible for the liquid dispenser body, including, without limitation, a cup, a pitcher, and a bowl. A straw 108 may be utilized to access the liquid inside the liquid dispenser body. In some embodiments, a solid dispenser body 106 may rest above the liquid dispenser body. The solid dispenser body may be configured to contain and dispense a food. However, in other embodiments, the solid dispenser body may contain and dispense a solid item, including, without limitation, soil, building materials, medicines, and containers. A segregation portion may separate the solid dispenser body from the liquid dispenser body. The segregation portion may include an insulation portion to regulate thermal energy from the solid and the liquid. In one embodiment, the solid dispenser body may securely join with the liquid dispenser body, thereby forming a spill proof seal. The mechanism for mating may include, without limitation, a screw, a magnet, a snap, a fastener, and an adhesive. In one alternative embodiment, the liquid dispenser body may include a threaded neck section that extends through a female section of the solid dispenser body, wherein rotation of the solid dispenser body in a first direction urges the solid dispenser body downwardly into engagement with the liquid dispenser body. The engagement may create a spill proof seal between the liquid dispenser body and the solid dispenser body. Suitable materials for fabricating the dispenser assembly may include, without limitation, paper, cardboard, foam, plastic, wood, aluminum, fiberglass, and polymer synthetics.

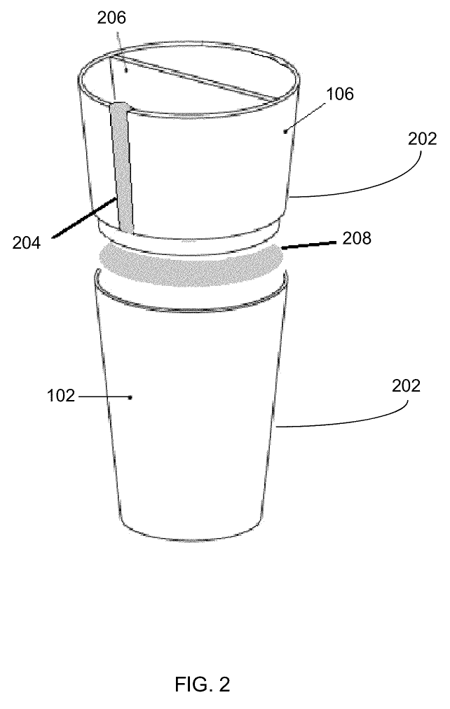

FIG. 2 illustrates a perspective view of an exemplary dispenser apparatus with an exemplary barrier and an exemplary peripheral wall, in accordance with an embodiment of the present invention. In the present invention, the solid dispenser body and the liquid dispenser body may be separated by a segregation portion 208. The segregation portion may include an insulation portion to regulate thermal energy from the solid and the liquid. In one embodiment, the solid dispenser body and the liquid dispenser body may include a peripheral wall 202 that serves to provide an external barrier for containing the food. The peripheral wall may also function as an insulator for regulating thermal energy. In one embodiment, the peripheral wall may be configured to at least partially receive at least one aperture 204. The at least one aperture 112 may be a groove configured to at least partially receive the straw. In one embodiment, the at least one aperture may pass through a longitudinal section of the peripheral wall, from a top section of the solid dispenser body, to an open section of the liquid dispenser body. In this manner, the aperture may pass from the top of the solid dispenser body to the liquid inside the liquid dispenser body. Those skilled in the art, in light of the teachings of the present invention, will recognize that by passing the straw through the groove in the peripheral wall, the straw may contact the liquid without engaging the food. However, in an alternative embodiment, the at least one aperture may allow the straw to pass through an opening in the solid dispenser body, whereby the straw may engage the food.

In one embodiment of the present invention, at least one barrier 206 may segregate the solid dispenser body into a plurality of compartments for different varieties of food. Any number of divisions by the at least one barrier may be possible. In one alternative embodiment, each compartment that is created from the at least one barrier may include a variable depth for the solid dispenser body, depending on the variety of food intended for each compartment. In this manner, foods with high viscosity, such as dipping sauces and dressings, may position next to more solid foods in a volume that is proportional to the needs of the user.

In one embodiment of the present invention, the segregation portion may include an insulating portion disposed to position between the solid dispenser body and the liquid dispenser body. The insulation portion may serve to restrict thermal transfer between the solid and the liquid. In one alternative embodiment, a heater may warm food in the solid dispenser body and the liquid dispenser body. The insulating portion may be beneficial when hot or cold liquids rest inside the liquid dispenser body, thereby serving to keep coffee hot and prevent ice from melting. In some embodiments, the insulating portion may include a circular foam piece that securely juxtapositions between the solid dispenser body and the liquid dispenser body. Those skilled in the art, in light of the present teachings, will recognize that the top of the liquid dispenser body may include threads that engage with the bottom of the solid dispenser body to provide a secure, spill proof attachment. The threaded attachment may also create a secure positioning for the insulating portion. In an alternative embodiment, the entire liquid dispenser body may be insulated to provide greater protection from thermal transfer, in combination with the insulating portion. Suitable materials for the insulation portion may include, without limitation, foam, cardboard, and fiberglass.

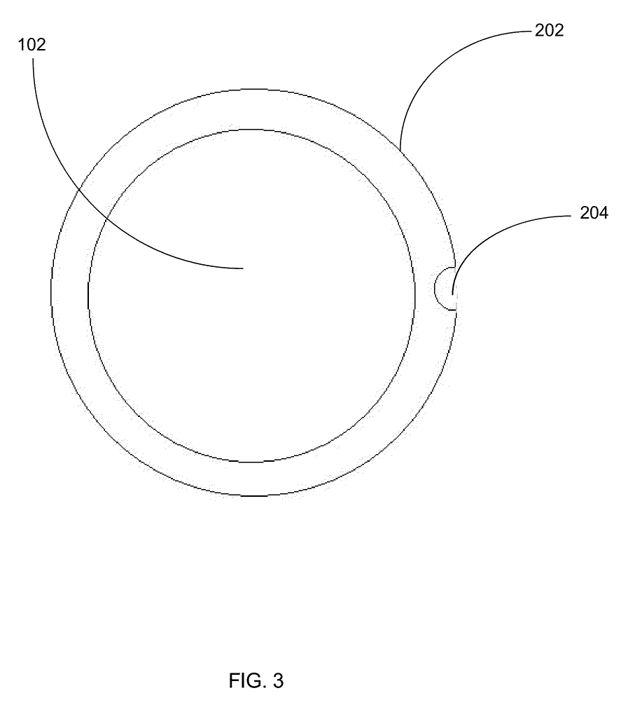

FIG. 3 illustrates a top view of an exemplary solid dispenser body, in accordance with an embodiment of the present invention. In the present invention, the solid dispenser body may be segregated with at least one barrier. In this manner, the food may be portioned into the solid dispenser body depending on the type of food and requirements of the user. In some embodiments, different foods may be segregated in the solid dispenser body, depending on the amount of the at least one barrier utilized. In some embodiments, an insulating portion may be positioned beneath the solid dispenser body and above the liquid dispenser body. In this manner, the solid dispenser body may be securely mated on top of the liquid dispenser body, sandwiching the insulating member securely in the middle.

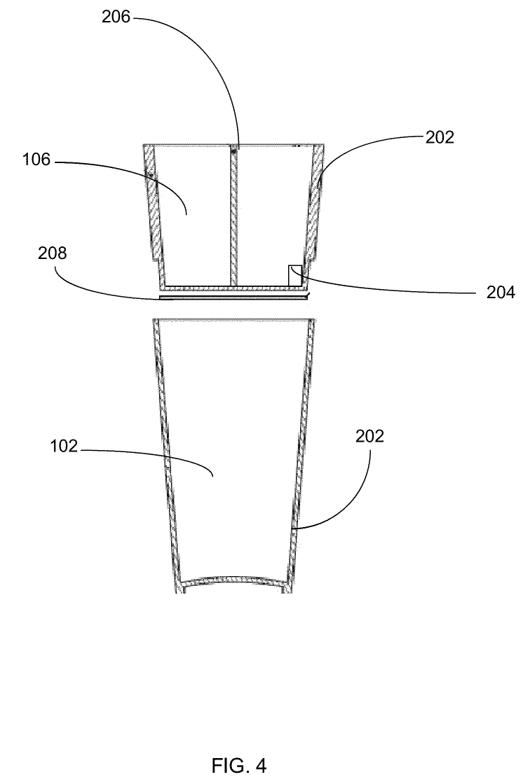

FIG. 4 illustrates a side view of a side view of an exemplary dispenser apparatus, in accordance with an embodiment of the present invention. In the present invention, the solid dispenser body and the liquid dispenser body may be segregated with at least one barrier. The liquid may be portioned into the liquid dispenser body, and the food may be portioned into the solid dispenser body. In some embodiments, different foods may be segregated in the solid dispenser body, depending on the amount of the at least one barrier utilized. The insulating portion may be positioned above the liquid dispenser body. The solid dispenser body may be securely mated on top of the liquid dispenser body, sandwiching the insulating member securely in the middle. A straw may pass through the aperture until the straw engages the liquid. A user may then be able to simultaneously consume the liquid and the food with one hand.

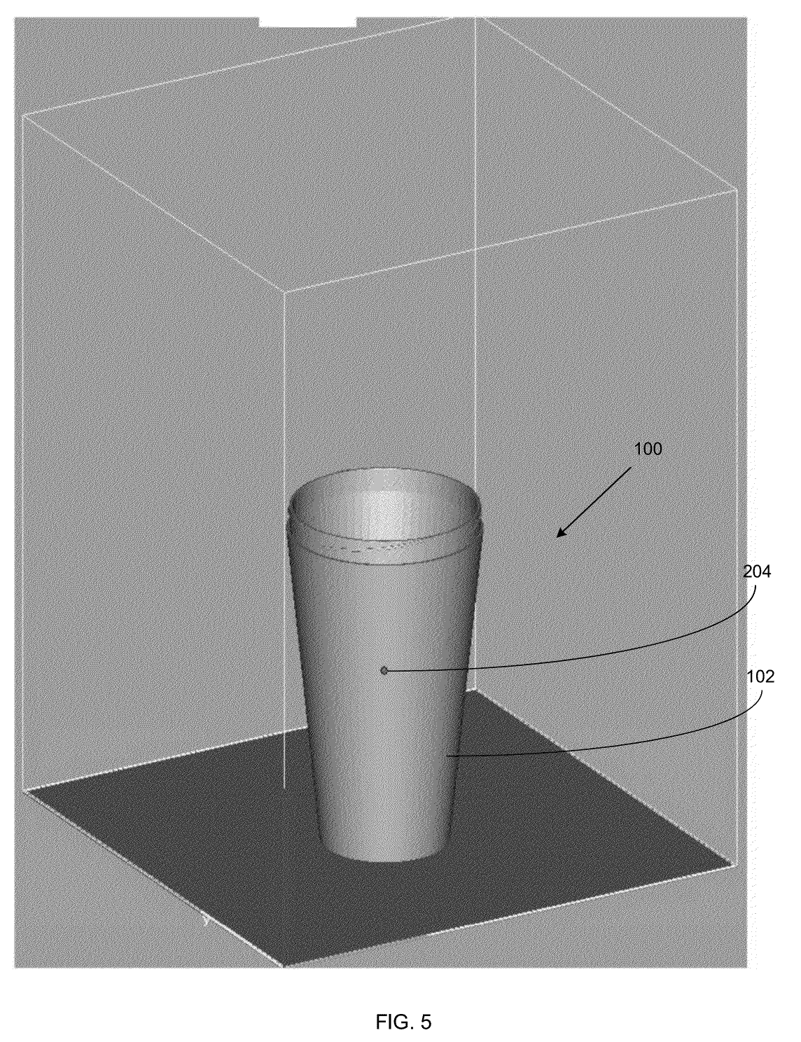

FIG. 5 illustrates a perspective view of an exemplary liquid dispenser body with an exemplary aperture positioned directly into the liquid dispenser body for passing an exemplary straw through, in accordance with an embodiment of the present invention. In the present invention, the straw may pass through the aperture positioned directly into the body of the liquid dispenser body. In one alternative embodiment, the straw may include a pump for sucking the liquid from the liquid dispenser body. In another alternative embodiment, the straw may be built into the dispenser apparatus and retract from the liquid dispenser body as desired.

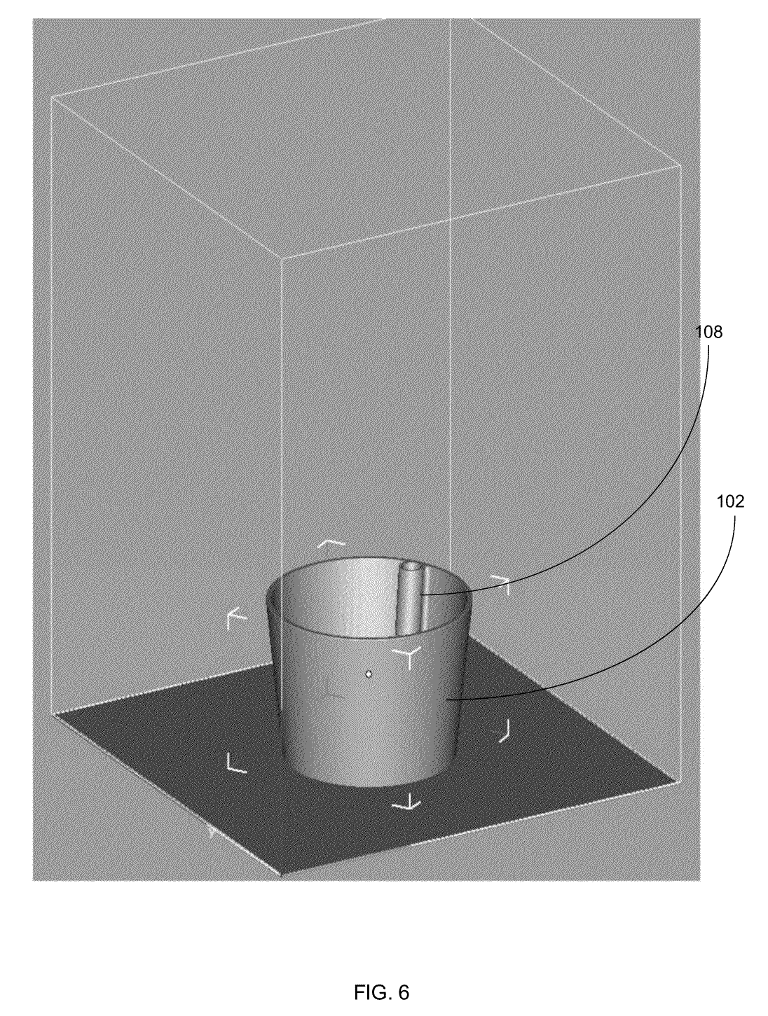

FIG. 6 illustrates a perspective view of an exemplary liquid dispenser body separate from a solid dispenser body, and having an exemplary straw positioned directly into an exemplary aperture, in accordance with an embodiment of the present invention. In the present invention, the liquid dispenser body may be solid and include no aperture or solid dispenser body, whereby the straw positions directly in an opening of the liquid dispenser body. The liquid may include, without limitation, soda, hot chocolate, alcohol, and milk.

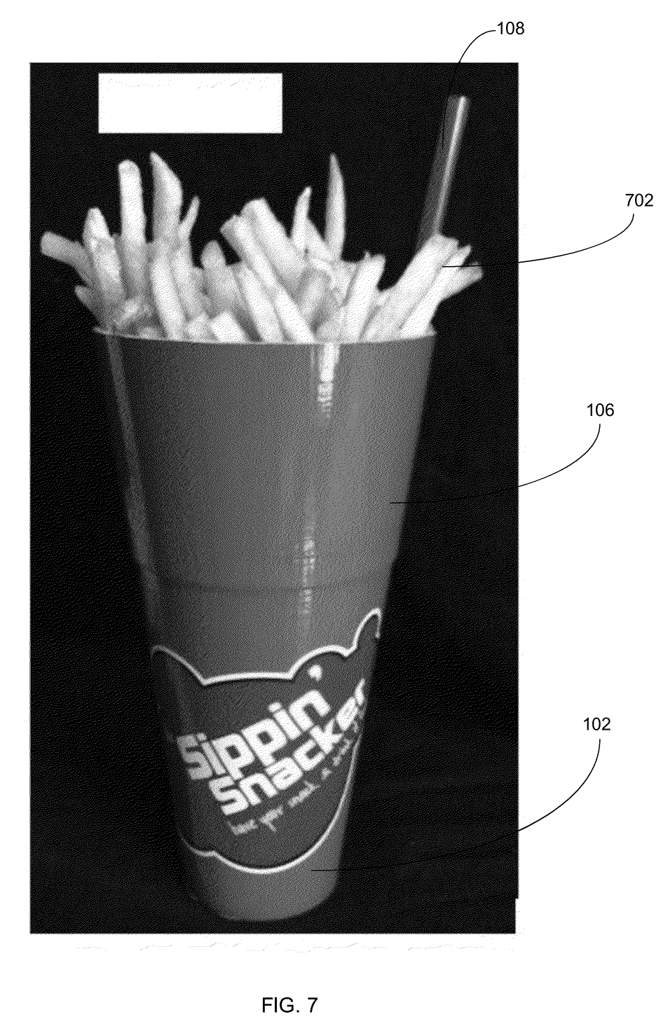

FIG. 7 illustrates a perspective view of an exemplary dispenser apparatus with an exemplary food positioned inside an exemplary solid dispenser body, in accordance with an embodiment of the present invention. In the present invention, a food 702 may position directly inside the solid dispenser body. The food may include, without limitation, french fries, popcorn, hotdogs, condiments, and stew. Those skilled in the art, in light of the present teachings, will recognize that each food may contain a particular odor, texture, taste, and grease content. Segregating the eclectic variety of foods may help preserve the taste and integrity of the foods.

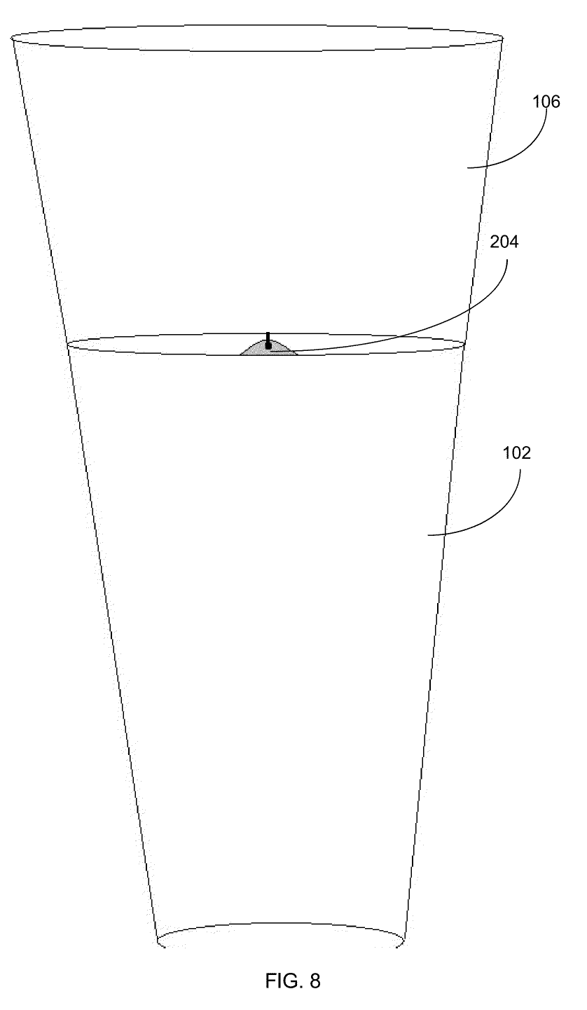

FIG. 8 illustrates a sectioned view of an exemplary dispenser apparatus with an exemplary aperture for inserting an exemplary straw located between an exemplary solid dispenser body and an exemplary liquid dispenser body, in accordance with an embodiment of the present invention. In the present invention, the aperture may at least partially enable the straw to pass through the solid dispenser body and/or the segregation portion, whereby the straw may engages the food as the liquid passes through. In one alternative embodiment, the temperature of the liquid may be made to match the temperature of the food in this manner.

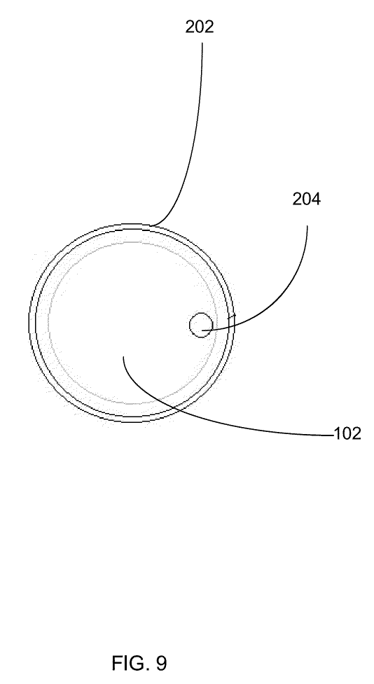

FIG. 9 illustrates a top view of an exemplary solid dispenser body with an exemplary aperture positioned inside an exemplary peripheral wall around the perimeter of the solid dispenser body, in accordance with an embodiment of the present invention. In the present invention, an insulated lid may position on a top section of the solid dispenser body to prevent heat or cold loss from the food. In an alternative embodiment, the entire solid dispenser body may be insulated to provide greater protection from thermal transfer, in combination with the insulating member.

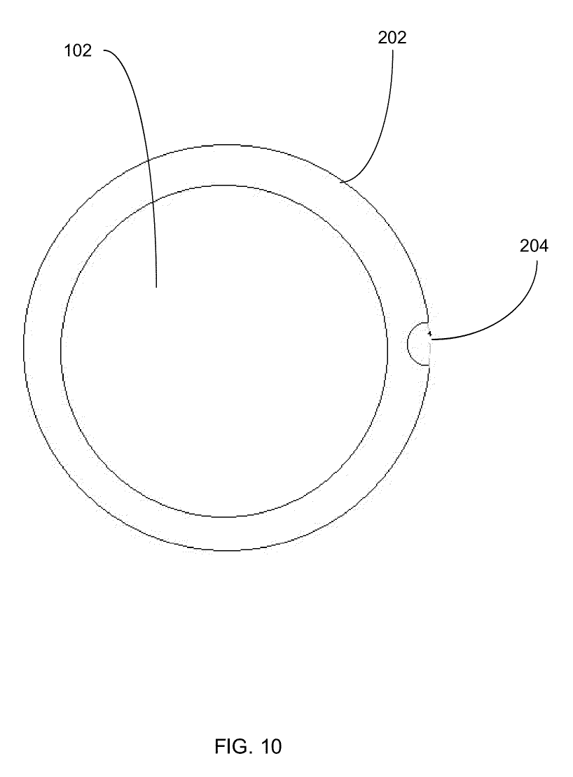

FIG. 10 illustrates a top view of an exemplary solid dispenser body with an exemplary aperture positioned outside an exemplary peripheral wall around the perimeter of the solid dispenser body, whereby the straw does not contact the food, in accordance with an embodiment of the present invention. In the present invention, the aperture may pass through a longitudinal section of the peripheral wall, from a top section of the solid dispenser body, to an open section of the liquid dispenser body. In this manner, the aperture may pass from the top of the solid dispenser body to the liquid inside the liquid dispenser body. Those skilled in the art, in light of the teachings of the present invention, will recognize that by passing the straw through the groove in the peripheral wall, the straw may contact the liquid without engaging the food.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a food and liquid dispenser that allows for simultaneous access to food and liquid according to the present invention will be apparent to those skilled in the art. Various aspects of the invention have been described above by way of illustration, and the specific embodiments disclosed are not intended to limit the invention to the particular forms disclosed. The particular implementation of the segmented food and liquid dispenser that allows for simultaneous access to food and liquid may vary depending upon the particular context or application. By way of example, and not limitation, the segmented food and liquid dispenser that allows for simultaneous access to food and liquid described in the foregoing were principally directed to a solid dispenser that secures atop a liquid dispenser for facilitated access to the food and liquid inside each implementations; however, similar techniques may instead be applied to food storage in large wheat and corn silos, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a liquid dispenser body, said liquid dispenser body being configured to contain a liquid;
a solid dispenser body, said solid dispenser body being configured to contain a solid, said solid dispenser body being disposed to join with said liquid dispenser body;
a segregation portion, said segregation portion being disposed to segregate said liquid dispenser body from said solid dispenser body;
at least one aperture, said at least one aperture being disposed to position on said solid dispenser body, and/or said liquid dispenser body, and/or said segregation portion; and
a straw, said straw being disposed to at least partially pass through said at least one aperture.

2. The apparatus of claim 1, wherein said solid dispenser body is disposed to position above said liquid dispenser body.

3. The apparatus of claim 1, in which said liquid dispenser body comprises a threaded neck, said threaded neck being configured to at least partially extend through an opening in said solid dispenser body.

4. The apparatus of claim 3, wherein rotation of said solid dispenser body in a first direction at least partially urges said solid dispenser body downwardly into engagement with said liquid dispenser body.

5. The apparatus of claim 1, in which said solid dispenser body and/or said liquid dispenser body comprises a peripheral wall.

6. The apparatus of claim 5, in which said peripheral wall comprises said at least one aperture.

7. The apparatus of claim 6, wherein said straw is disposed to at least partially pass through a longitudinal section of said peripheral wall, from a top section of said solid dispenser body, to an open section of said liquid dispenser body.

8. The apparatus of claim 7, in which said straw is operable to engage said liquid.

9. The apparatus of claim 8, in which said peripheral wall comprises an insulation portion.

10. The apparatus of claim 9, in which said insulation portion comprises foam.

11. The apparatus of claim 10, in which said segregation portion comprises said insulation portion.

12. The apparatus of claim 1, in which said segregation portion is configured to form a spill proof seal between said solid dispenser body and said liquid dispenser body.

13. The apparatus of claim 1, in which said solid dispenser body comprises at least one barrier.

14. The apparatus of claim 13, wherein said at least one barrier is configured to segregate said solid dispenser body into a plurality of compartments.

15. The apparatus of claim 14, in which said plurality of compartment comprise different elevations.

16. The apparatus of claim 1, in which solid dispenser body comprises an insulated lid.

17. The apparatus of claim 1, in which said solid comprises a food.

18. The apparatus of claim 1, in which said liquid comprises a beverage.

19. An apparatus comprising:
means for positioning a solid in a solid dispenser body;
means for positioning a liquid in a liquid dispenser body;
means for joining said solid dispenser body with said liquid dispenser body;
means for passing a straw through at least one aperture;
means for dispensing a solid from said solid dispenser body; and
means for dispensing a liquid from said liquid dispenser body.

20. An apparatus consisting of:
a liquid dispenser body, said liquid dispenser body being configured to contain a liquid, said liquid comprising a beverage, said liquid dispenser body comprising a peripheral wall;
a solid dispenser body, said solid dispenser body being configured to contain a solid, said solid comprising a food, said solid dispenser body comprising a peripheral wall, said solid dispenser body being disposed to join with said liquid dispenser body, said liquid dispenser body comprises a threaded neck, said threaded neck being configured to at least partially extend through an opening in said solid dispenser body, said solid dispenser body further comprising at least one barrier, said at least one barrier being configured to compartmentalize said solid dispenser container into a plurality of compartments;
a segregation portion, said segregation portion being disposed to segregate said liquid dispenser body from said solid dispenser body, said segregation portion comprising an insulation portion, said insulation portion being configured to at least partially restrict transfer of thermal energy between said solid dispenser body and said liquid dispenser body;
at least one aperture, said at least one aperture being disposed to position on said solid dispenser body, and/or said liquid dispenser body, and/or said segregation portion; and
a straw, said straw being disposed to at least partially pass through said at least one aperture, said straw further being disposed to at least partially pass through a longitudinal section of said peripheral wall, from a top section of said solid dispenser body, to an open section of said liquid dispenser body, said straw being configured to engage said liquid.
